(19) United States
(12) Patent Application Publication
(10) Pub. No.: US 2025/0224708 A1
(43) Pub. Date: Jul. 10, 2025

(54) DETERMINING PROPERTIES OF POWDER BED FUSION ADDITIVE MANUFACTURING PRODUCED COMPONENTS

(71) Applicant: Ocado Innovation Limited, Hatfield (GB)

(72) Inventors: Andreas Carl Erik RUNFALK, Hatfield Hertfordshire (GB); Thomas James BREARLEY, Hatfield Hertfordshire (GB); Dominik Krystian PRZEPIÓRA, Hatfield Hertfordshire (GB)

(21) Appl. No.: 19/060,296

(22) Filed: Feb. 21, 2025

Related U.S. Application Data
(63) Continuation of application No. PCT/EP2023/073032, filed on Aug. 22, 2023.

(30) Foreign Application Priority Data
Aug. 23, 2022 (GB) 2212266.7

(51) Int. Cl. G05B 19/4099

(52) U.S. Cl. CPC G05B 19/4099; G05B 2219/49023

(57) ABSTRACT

A method for manufacturing components is disclosed. Each component of a batch of components is assigned a respective unique identifier. The batch of components is manufactured using a powder bed fusion additive manufacturing, powder bed fusion additive manufacturing, system, wherein each component of the batch of components comprises a respective unique identifier. Each unique identifier can be used to provide a comprehensive understanding of the component.

### CROSS-REFERENCE TO RELATED APPLICATIONS

This Application is a continuation of International Patent Application No. PCT/EP2023/073032, filed on Aug. 22, 2023, which claims priority to GB Application No. 2212266.7, filed on Aug. 23, 2022, the entire contents of each of which are hereby incorporated by reference.

### BACKGROUND

### Technical Field

The present invention relates to determining properties of manufactured components. The properties include information about the component and manufacturing properties. Knowledge of the properties can be used to improve the component.

Powder bed fusion additive manufacturing, PBFAM, processes are well known. Typically, the PBFAM process begins with a 3D CAD model of a component. Appropriate software slices the 3D CAD model into discrete layers, which can be thought of as a series of cross-sections of the component. The PBFAM process produces the component layer-by-layer, with each layer corresponding to a discrete layer (or cross-section). Each layer is formed from powder that is spread over a build platform in a build volume of the PBFAM system. An energy source, such as a thermal print head, laser, infra-red source, or electron beam is used to sinter, fuse, or melt the powder and produce the current layer. This means each layer has powder that is both unaltered and powder that has been transformed to form the current layer. Once the current layer is formed, the process is repeated to form a new layer on the previous layer until all the discrete layers (or cross-sections) defining the component have been formed.

An example PBFAM process and related system 100 is shown in FIG. 1. When the current layer has been produced by the heat source, laser, or electron beam acting on the powder (i.e. an energy source 110), the build platform 120 is lowered by a distance corresponding to the thickness of a discrete layer. A roller or blade 130 is used to apply a new layer of powder 140 over the previous layer. The new layer of powder is provided by raising platform 150. The heat source, laser, or electron beam then acts on the new layer of powder to form a new layer over the previous layer. This process continues until components 160 are formed. As shown in FIG. 1, the build volume 170 comprises the produced components 160 and unfused, un-sintered, or unmelted powder (i.e. unaltered powder) 180. This unaltered powder is removed during a post processing operation to obtain the component.

Typical powder materials include plastics such as nylon, metals such as aluminum, and alloys such as titanium-based alloys. Known PBFAM processes include Selective Laser Sintering, SLS, Selective Laser Melting, SLM, Direct Metal Laser Sintering, DMLS, Electron Beam Melting, EBM, and Multi Jet Fusion, MJF.

Typically, millions of components are produced for a common use, such as building a particular system. Although distinguishing one component from another component may be possible by visual inspection when the components are different, this is not practical when the number of components is high. Even if components can be distinguished in this way, a group of identical components in respect of appearance and configuration could have different uses or have been manufactured using different processes. Given the number of different processes available, it can be difficult to determine component information and/or how it was manufactured from examining the component itself. In other words, components that appear identical could in fact be different from a use/deployment and/or manufacturing perspective.

Whilst each component could be labelled immediately after manufacture, such a process is inefficient. For example, individual labels would have to be manually recorded against component data including manufacturing data, such as the type of PBFAM process used. During a typical PBFAM process, appropriate settings are used on the PBFAM system. The PBFAM system can also monitor the process and generate real-time data. However, neither the setting nor the real-time data is used beyond the operation of the PBFAM system itself. The settings and real-time data could nonetheless be useful when associated with a component. When the number of components made is significant, recording such information becomes particularly burdensome and prone to errors. Even if the manufacturing properties of each component are recorded in this way, the ability to record certain manufacturing properties would nonetheless be lost.

One such example is when a number of identical components are produced within the build volume. The process by which the components are arranged/formed in the build volume can be controlled by a nesting algorithm. The goal of the nesting algorithm is to optimize the use of the space within the build volume, which in turn saves costs and increases productivity. In particular, as much of the available space in the build volume as possible should be used for components. In other words, the amount of unaltered powder in the build volume should be minimized. The nesting algorithm analyses 3D CAD models of the components and arranges and orientates the components to maximize the number of components that can be obtained from the build volume. Nesting algorithm software can be fully automated, manual, or a combination thereof.

As mentioned above, the unaltered powder has to be removed in a post processing step to obtain the components. The post processing step involves an operator manually breaking up the build volume to obtain the components and remove as much powder as possible. When the build volume is used to produce a large number of identical components (e.g. at least 100), it is impossible to track where each component originated from in the build volume. For example, during post processing, the build volume may break up in an unpredictable manner such that components are obtained in an order that has little or no resemblance to their arrangement in the build volume. FIG. 2 shows such a build volume 270 with 27 components 260. During post processing, a group of components may collapse together then break up before they can otherwise be removed. The task of labelling the original order/arrangement of components, as set by the nesting algorithm, during post processing is akin to trying to identify where a building block of a demolished high rise building was located in the high rise building.

Knowing the configuration of the PBFAM system, and/or where components were located and thus formed in the build volume is useful when assessing the performance or quality of the components. If a particular component is shown to be sub-optimal, or fails in a consistent way, it may be the case that changing a setting of the PBFAM system, and/or the location/orientation of the component in the build volume could improve the performance or quality of this component when subsequently manufactured.

There is generally a need for determining information including manufacturing properties of components produced by a PBFAM system. There is also a need to use the determined manufacturing properties to improve the quality of a component produced in a subsequent PBFAM system. There is also a need to easily access information including manufacturing properties of a component using a database.

Such components may be used in a load handling device such as that described in UK Patent Application No. GB2520104A (Ocado Innovation Limited). A load handling device is an automated system having moving components/parts. Having detailed information on all of the components/parts can help optimize operation of the load-handling device.

### SUMMARY

In one aspect, there is a method for manufacturing components, the method comprising: assigning a respective unique identifier to each respective component of a batch of components; and manufacturing the batch of components using a powder bed fusion additive manufacturing, PBFAM system, wherein each component of the batch of components comprises a respective unique identifier. This means any one component in isolation can be distinguished from any other component in the batch.

The method may further comprise interfacing with and updating a nesting file to manufacture each component of the batch of components comprising the respective unique identifier. This means the above aspect can be easily integrated into an existing manufacturing process.

Each respective unique identifier may indicate at least one property of a respective component of the batch of components. This means each unique identifier can go beyond merely identifying the component.

The at least one property may comprise a manufacturing property. This means each component can be distinguished by the manufacturing process used.

The at least one manufacturing property may comprise at least one of a respective location of the respective component of the batch of components within a build volume of the PBFAM system, a powder bed temperature setting of the PBFAM system, an energy source setting of the PBFAM system, a speed of powder spreading of the PBFAM system, an inkjet array setting of the PBFAM system, at least one material used in the PBFAM system, a model of the PBFAM system, a job number of the PBFAM system, a batch number of the batch of components, a material from which the components are manufactured, and a time and/or duration of the manufacturing of the batch of components. This means each component can be distinguished by the precise manufacturing process used.

The method may further comprise interfacing with a nesting algorithm to receive the respective locations in the build volume. This means the exact locations of the components during the manufacturing process are known and recorded.

The method may further comprise interfacing with the PBFAM system to receive at least one of the powder bed temperature setting of the PBFAM system, the energy source setting of the PBFAM system, the speed of powder spreading of the PBFAM system, and the inkjet array setting of the PBFAM system. This means the exact parameters/settings of the PBFAM system used during the manufacturing process are known and recorded.

The at least one of the powder bed temperature setting of the PBFAM system, the energy source setting of the PBFAM system, the speed of powder spreading of the PBFAM system, and the inkjet array setting of the PBFAM system may be received in real-time as the components are manufactured. This means any variations in parameters/settings used during the manufacturing process are known and recorded.

The at least one property may comprise information, the information comprising at least one of a design of the component, a description of the component, an installation instruction of the component, a system in which the component is used, a revision number of the component, a compatibility of the component with other components or a system in which the component is used, geometric dimensioning and tolerancing data of the component, and a location within a load handling device in which the component is used. This means each component can be distinguished by use thereof.

The method may further comprise mapping the at least one property to a respective unique identifier for each component, and using the mapping to indicate the at least one property of a respective component. The method may further comprise storing the respective unique identifier, the at least one property, and the mapping for each component in a database. This means a comprehensive understanding of each component can be provided.

The method may further comprise determining a performance of at least one component of the batch of components, upon determining that the performance of at least one component can be improved, using the unique identifier of the at least one component to determine at least one property of the component, modifying at least one property of a component to improve performance, and manufacturing the component with the modified at least one property.

Manufacturing the component with the modified at least one property may comprise manufacturing the component as part of a subsequent batch of components using a PBFAM system. This means the next version of the component has improved performance compared to a component of the batch of components.

The at least one property of the component of the batch of components may comprise a mechanical property comprising a respective location within a build volume of the PBFAM system that manufactured the batch of components, and modifying the least one property of the component of the subsequent batch of components may comprise modifying the respective location in a build volume of the PBFAM system that manufactures the subsequent batch of components. This means that orientation/location originating defects of the components may be corrected.

The method may further comprise interfacing with a nesting algorithm to modify the respective location in the build volume of the PBFAM system that manufactures the subsequent batch of components. This means the component will be free of orientation/location originating defects.

Modifying the respective location may comprise at least one of constraining rotational freedom of each component, prioritizing components, defining no-build zones to ensure a minimum spacing between parts, forming sacrificial cases/covers to group and/or protect certain components, altering the total number of components in the build volume, and altering a thickness of each PBFAM layer that is used to form the components in the PBFAM system. This means that a build volume can be optimized in terms of improving the quality of all components produced therein.

The at least one property of the component of the batch of components may comprise a mechanical property comprising at least one of the powder bed temperature setting of the PBFAM system, the energy source setting of the PBFAM system, the speed of powder spreading of the PBFAM system, and the inkjet array setting of the PBFAM system, and modifying the at least property of the component of the subsequent batch of components may comprise modifying at least one of the powder bed temperature setting of the PBFAM system that manufactures the subsequent batch of components, the energy source setting of the PBFAM system that manufactures the subsequent batch of components, the speed of powder spreading in the PBFAM system that manufactures the subsequent batch of components, and the inkjet array setting that of the PBFAM system that manufactures the subsequent batch of components. This means the PBFAM manufacturing process can undergo precise adjustments to improve a performance of the component.

The method may further comprise assigning a respective unique identifier to the component or each respective component of the subsequent batch of components. This means any one component in isolation can be distinguished from any other component in the subsequent batch.

Each respective identifier may indicate at least one property of a respective component of the subsequent batch of components, and wherein each component of the subsequent batch of components comprises a respective unique identifier. This means each unique identifier can go beyond merely identifying the component.

The method may further comprise determining whether at least one component of a plurality of components has a similar or identical property to the component for which it was determined that performance can be improved, and upon determining that at least one component of the plurality of components has a similar or identical property to the component for which it was determined that performance can be improved, providing the or each respective unique identifier of the or each component of the plurality of components. This means components can be proactively identified and recalled and/or modified if necessary.

The unique identifier indicates a feature of the component, or wherein manufacturing the batch of components further comprises forming at least one feature identifier on the component. This means a user can determined how to use and/or install the component.

Each respective identifier may be formed by an embossing or a debossing on each respective component, or at least one feature identifier may be formed by an embossing or a debossing on each respective component. This means the identifier will persist even in the presence of wear.

Each component of the batch of components comprises the respective unique identifier on a designated area of the component. This means the unique identifier does not adversely affect the component.

In another aspect, there is a computer program comprising instructions which, when the program is executed by a computer, cause the computer to carry out the method of any aspect above.

In another aspect, there is a data processing system comprising a processor configured to carry out the method of any aspect above.

### DESCRIPTION OF DRAWINGS

The present invention is described with reference to one or more exemplary embodiments as depicted in the accompanying drawings, wherein:

FIG. 1 shows a powder based fusion additive manufacturing system;

FIG. 2 shows a build volume with a number of components;

FIG. 3 shows a method for manufacturing components according to the invention;

FIG. 4 shows a component with a unique identifier according to the invention;

FIG. 5 shows a system that carries out the method of FIG. 3;

FIG. 6 shows a method of improving the performance of a component according to the invention;

FIG. 7 shows a method of identifying components of a plurality of components for which performance can be improved according to the invention;

FIG. 8 shows a method of searching a database according to the invention;

FIG. 9 shows a user interface/front-end that can be used with the method of FIG. 8.

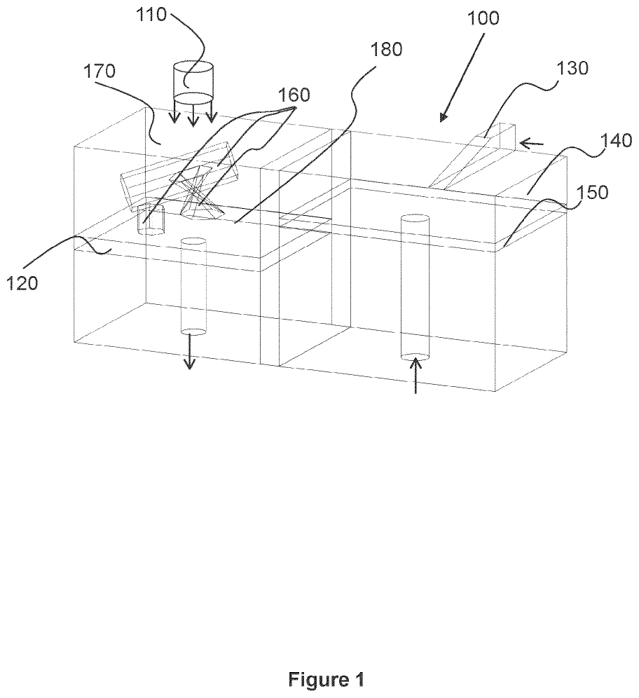

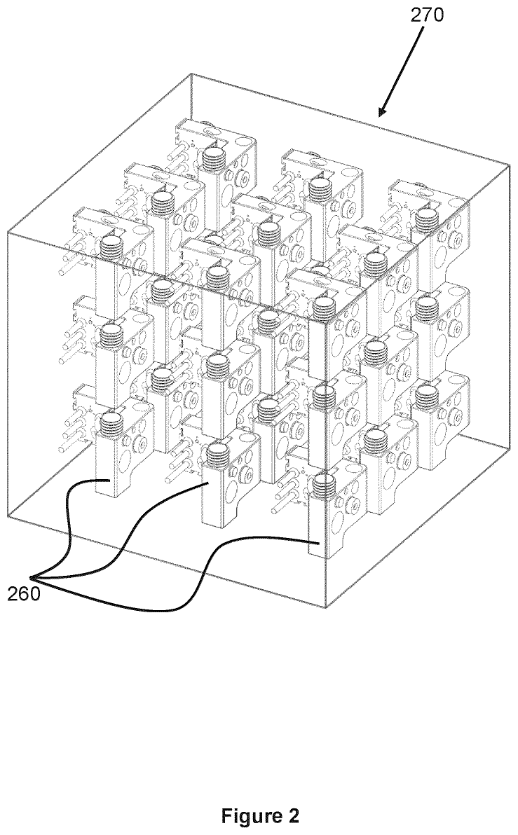

### DETAILED DESCRIPTION

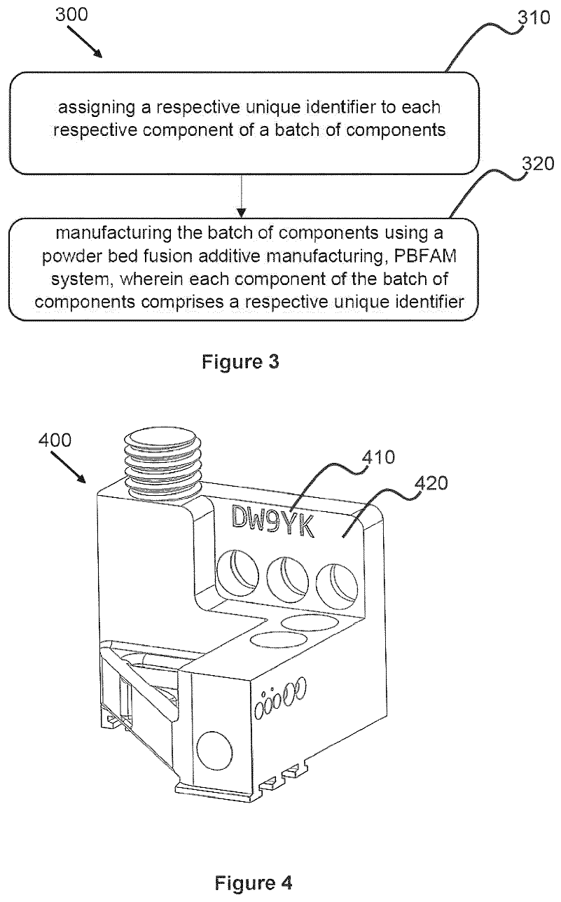

FIG. 3 shows the steps of a method 300 for manufacturing components. In step 310, a unique respective identifier is assigned to each respective component of a batch of components. A batch of components are components that are produced simultaneously using a PBFAM system. The components may be different, similar/identical, or a combination thereof (e.g. a first set of similar/identical components and a second set of different components). The total number of components varies depending on the sizes of the components and the build volume. Thus, components are considered to form a batch of components when they are manufactured together in a PBFAM system, irrespective of the type of components or number thereof.

Advantageously, the respective unique identifier can be used to uniquely identify the component with which it is associated. One example of the respective identifier includes a character string. The number of characters in the string can be set depending on the number of components to be manufactured. Additionally or alternatively, typographical symbols may be used. Another example is a 3D quick response, QR, code, or a bar code.

In step 320, the PBFAM system is used to manufacture the batch of components. Each component is manufactured to include its respective identifier. This way, each component has a permanent indication of its respective unique identifier. The respective unique identifier can be included by way of embossing or debossing for example, which ensures that the identifier will persist even if the component is subject to wear. Debossing may be preferable where the outer profile of the component cannot accommodate additional height that results from embossing. Embossing may be preferable where removal of material that results from debossing could adversely affect performance of the component. Each component of the batch of components can be uniquely identified on the basis of its respective identifier, even if the components are otherwise identical in respect of appearance and configuration. Additionally, if several batches of components are produced using the method of FIG. 3, each component can be uniquely identified. That is, the unique identifier is unique across all batches produced using the method of FIG. 3. In other words, the unique identifier is not duplicated, and every component produced using the method of FIG. 3, and not just a current batch, will have a unique identifier. An example of a component made according to the process of FIG. 3 is shown in FIG. 4. The component 400 has a unique identifier 410 in a designated area 420.

The method of FIG. 3 has several advantages. As explained below, the unique identifier can be used to identify at least one property such as specific information on the component's use or a manufacturing property. This is particularly useful when mass produced systems incorporate the components produced by multiple iterations of the method of FIG. 3. During assembly, use, maintenance, or repair of such systems, being able to identify the constituent components has many advantages as explained below. Such a mass-produced system includes the load handling device referenced above. The load handling device referenced above may be a mobile grocery picking robot.

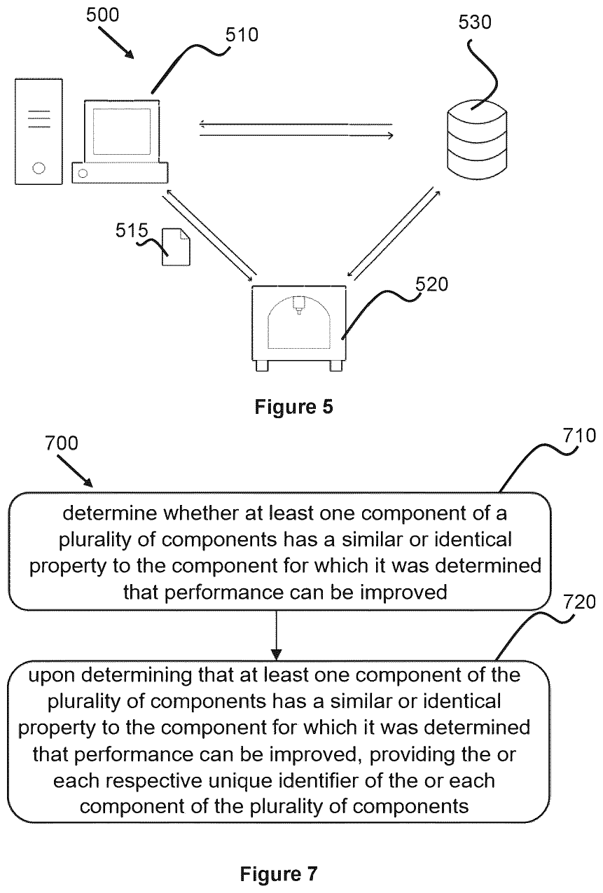

FIG. 5 shows a system 500 used to implement the method of FIG. 3. Computing device 510 is used to control PBFAM system 520. Computing device 510 receives or generates a file 515 comprising a number of components to be produced as a batch using the PBFAM system. The file 515 could be the nesting file that controls (as set by a nesting algorithm) where each component in the batch is located in the build volume. The components in the file can be generated from computer aided design, CAD, software. An area 420, as shown in FIG. 4, on each component that is designated for the identifier is assigned to each component. The designated area can be one that makes the unique identifier readily assessable to a reading device such as a camera or scanner. Similarly, the designated area can be located in a region that does not adversely affect the component's performance, such as a large or strong region. The computing device assigns the unique identifiers, and updates the file so that each component will be produced with its respective unique identifier on the designated area. The PBFAM system is then used to produce the batch of components with each component comprising a respective unique identifier on the area designated therefor. The computing device maps each unique identifier to at least one property of the respective component. Each unique identifier, the at least one property, and the associated mapping can then be stored in database 530.

Although shown as separate elements, it would be appreciated that a single piece of hardware could implement the functions of the computing device, PBFAM system, and database. For example, the PBFAM system could be programmed to process the file before printing and store each assigned unique identifier, the at least one property, and the associated mapping locally or on a networked device. Alternatively, the PBFAM system, could interface with a cloud computing platform to receive the file and store each unique identifier, the at least one property, and the associated mapping. As shown in FIG. 5, there is two-way communication between each of the computing device, PBFAM system, and database. This means that each of the computing device, PBFAM system, and database can send and receive data to one another to implement the method of FIG. 3.

The at least one property can include at least one manufacturing property including at least one of a respective location of the respective component of the batch of components within a build volume of the PBFAM system, a powder bed temperature setting of the PBFAM system, an energy source setting of the PBFAM system (an energy source could be understood as that which transforms the current powder layer to a discrete layer or cross-section of the component), a speed of powder spreading of the PBFAM system, an inkjet array setting of the PBFAM system, at least one material used in the PBFAM system, a model of the PBFAM system, a job number of the PBFAM system, a batch number of the batch of components, a material from which the components are manufactured by the PBFAM system, and a time and/or duration of the manufacturing of the batch of components. In general, manufacturing properties on the component should provide a comprehensive understanding of how exactly and under which conditions the component was manufactured. It would be appreciated that manufacturing properties can be generated from analyzing manufacturing data from the PBFAM system itself at any point before, during, and after production of the component. Additionally, the manufacturing properties can be updated on a real-time basis during the manufacturing process. Similarly, this information can be generated by the computing device 510 when preparing the file 515.

One option for generating a respective location of the respective component of the batch of components within a build volume of the PBFAM system is to analyze the nesting file that is used to control where each component is located in the build volume. The nesting file may be part of file 515. The nesting file for example defines the respective locations in terms of X, Y, Z co-ordinates, which can provide both absolute and relative locations and orientations of each component. In one example, whilst a respective location should identify the relevant location for a given component, it may also indicate which other components were formed in the immediate surrounding areas. Additionally, the nesting file may be saved for each component with the relevant component being identified. This means that the precise context in which each component was manufactured is preserved in the database.

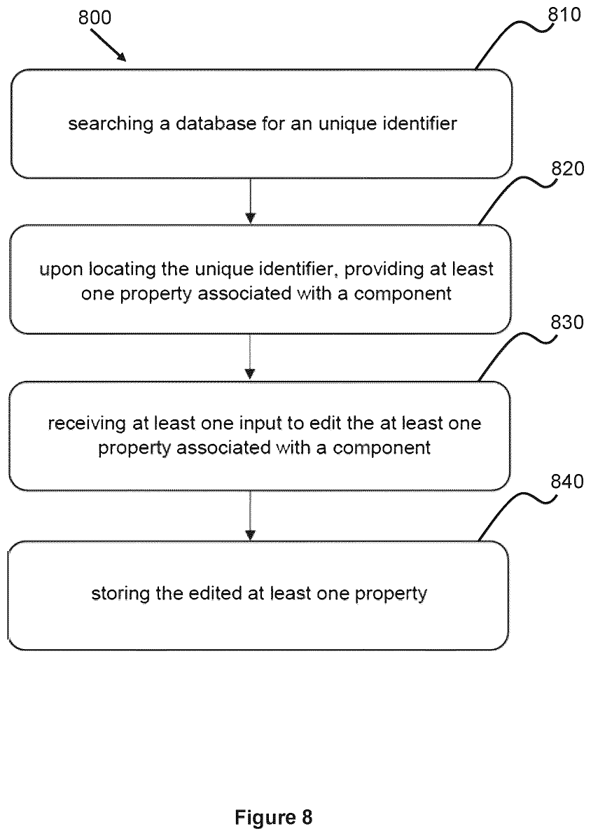

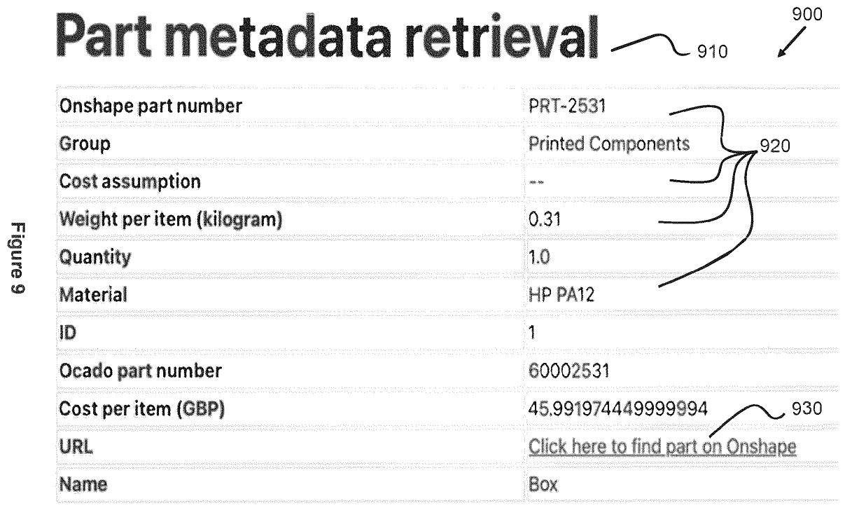

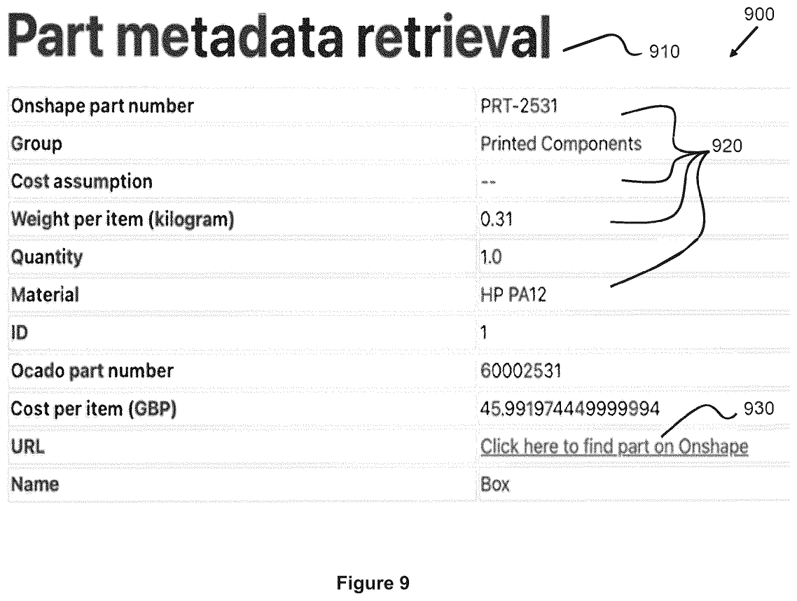

The at least one property can include information including at least one of a component serial number (this can be the same as the unique identifier is some implementations), a design of the component, a description of the component and its functionality, an installation instruction of the component, a system in which the component is used, a revision number of the component, a compatibility of the component with other components or a system in which the component is used, a location within a load handling device in which the component is used, geometric dimensioning and tolerancing data of the component, and a history of the development of the component. The information could also include feedback on the component including performance metrics such as faults, failures, usage cycles before failure, wear and tear (it would be appreciated that this type of information can either be observed or generated from analyzing a CAD file of the component, or software that simulates the performance of the component). In general, information on the component should provide a comprehensive understanding of all aspects of the component design, the component itself, and the use of the component. Of course, this information can also be updated during the lifetime of the product using measured/observed data, and for example as explained below with reference to FIGS. 8 and 9.

After the manufacturing process has been completed, the unique identifier of a component can be used to retrieve a mapping in the database to at least one property of the component. The unique identifier can be read using appropriate hardware such as a camera with OCR, QR code, or barcode recognition capabilities. Alternatively, an operator could visually inspect and note a charter string-based identifier. Thus, it is possible, for any component with the unique identifier, to obtain a comprehensive understanding of all aspects of the component including how exactly the component was manufactured. This comprehensive understanding can be applied to optimize both a component and use thereof.

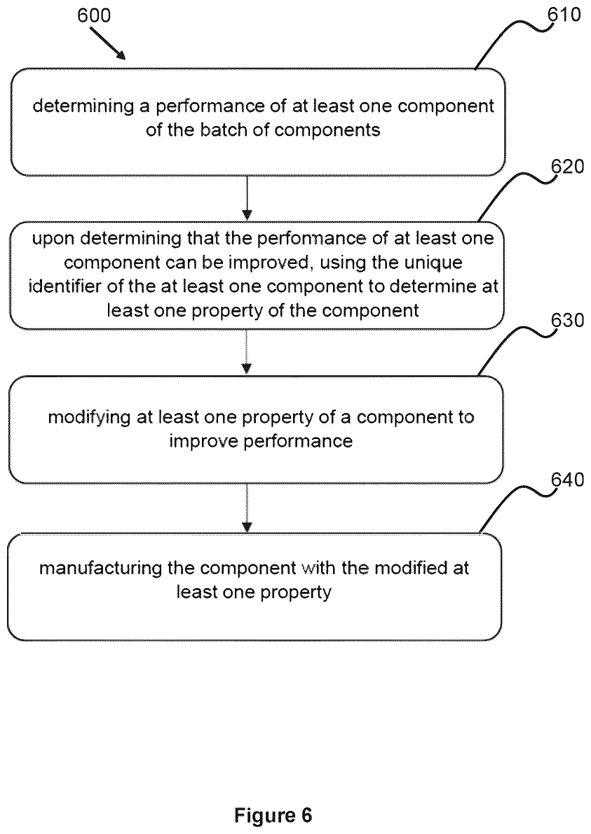

FIG. 6 shows a method 600 for optimizing a component. In step 610, a performance of at least one component of the batch of components is determined. The performance can be determined by evaluating the component against certain metrics relevant to the quality of the component such as: strength, elasticity, plasticity, hardness, toughness, brittleness, stiffness, ductility, malleability, cohesion, impact strength, fatigue, creep failure rate, failure locations/areas on the component, and usage cycle before failure. In general, a performance metric is one that allows assessment of the quality of a component. Maximizing the quality of a component is desirable, and this may involve consideration of a number of performance metrics. Of course, the number of metrics used to determine the quality, and what is considered an acceptable quality will vary depending on the nature and usage of a given component. It would be appreciated that performance metrics can be measured and/or simulated.

In step 620, upon determining that the performance of a given component can be improved, i.e. the component has an unacceptable quality, the unique identifier of the component is used to determine at least one property of the component. Typically, there is a causal link between the at least one property and the performance of the component. In other words, the performance metrics will depend on the at least one property. For example, the stiffness of the material depends on the structure of the component and the material from which it is made. Another example is where a failure area may be due to lack of structural reinforcement in the underlying design. This can occur when the component in use is attached, for example by a bolt, to another component and the torque applied to the bolt may damage the component. Another example is where the component splits along one of its axes which can be traced back to the orientation that the component had in the build volume. Yet another example is that where the component is located/oriented during formation may affect its rate of cooling. It may also be the case that the component is being used in a system with which it is not compatible. In general, a desired improvement to the performance of the component can be affected by considering the causal links between performance metrics and properties of the component. Accordingly, the process of FIG. 6 can be fully automated using knowledge of these causal links. A simulation may be used to verify whether the proposed modified property results in the desired improvement.

Thus, in step 630, a property of the component is modified to bring about the improvement when the next version of the component is subsequently produced. For example, the material or even the process from which the component is made can be changed to improve the stiffness. Another example is the addition of a reinforcement region to improve torque resilience. Yet another example is giving the component a different orientation in the build volume such that an axis of failure does not align with an axis in the build volume that results in structural weakness compared to other axes in the build volume.

In step 640, a component with the modified property is subsequently manufactured. The subsequently modified component will thus have improved performance, such as the examples listed above: improved stiffness, or torque resistance, or increased strength along a given axis. However, as mentioned above, it may have been determined that the component had an unacceptable quality due to being used in a system with which it was not compatible. The modified property may be updated compatibility information. This helps ensure that a future version of the component is only used with compatible components and/or systems so that the previous quality issues do not reappear. For example, the component may have been designed to withstand certain forces that are exceeded in certain systems. Restricting a subsequent version of this component so that it cannot be used in these certain systems means that it will not be subjected to forces that adversely affect its performance.

Although step 630 can be used to make a single component by any appropriate manufacturing technique, it will be appreciated that the component could form part of a subsequent batch of components that are made using an PBFAM system, or the method of FIG. 3 and the system of FIG. 5. This way, each component of the subsequent batch of components has a respective identifier that indicates at least one property, one of which is modified compared to an equivalent property in the batch of components. The performance of the component of the batch of components can also be added to the database. This allows iterative variations in the quality of the component to be linked with modified parameters, which ultimately helps optimize the component.

One advantage of using a PBFAM system is that a nesting file for the subsequent batch of components can be altered to affect the modification of the at least one property. Additionally, the nesting file can be used to affect the modification of several components in the subsequent batch of components. For example, the available rotational freedom for each component can be constrained, components can be prioritized, no-build zones can be defined to ensure a minimum spacing between parts; sacrificial cases/covers can be used to group and or protect certain components, the total number of components in the build volume can be altered, a thickness of each PBFAM layer (as determined by slicing the 3D CAD file) can be altered in the PBFAM system. Similarly, settings of the PBFAM can be modified such as the powder bed temperature setting of the PBFAM system, the energy source setting of the PBFAM system, the speed of powder spreading of the PBFAM system, and the inkjet array setting of the PBFAM system. At a general level, the PBFAM system can be configured to improve the quality of the components in the subsequent batch.

It will be appreciated that the method of FIG. 6 is not necessarily constrained to only improving components that were produced using the method of FIG. 3 and the system of FIG. 5. For example, legacy components that were produced by different means or even a different manufacturing method may nonetheless have an identifier, such as a post-production label, and a corresponding entry in the database. The component can thus be analyzed using the method of FIG. 6. This allows the design of legacy components to be optimized when the next version of the component is subsequently produced.

FIG. 7 shows a method 700 to identify all components that may have adverse performance due to a common property. As per steps 610 and 620 of FIG. 6, once it has been determined that a performance of a component can be improved, it is determined 710 whether at least one component of a plurality of components has a similar or identical property to the component for which it was determined that performance can be improved. Upon 720 determining that at least one component of the plurality of components has a similar or identical property to the component for which it was determined that performance can be improved, at least one respective unique identifier of the at least one respective component of the plurality of components is provided. This means that every component for which there is an entry in the database can be examined and any potential adverse performance issues can be pre-emptively addressed. For example, future versions of these components can have at least one property modified to improve the performance as explained above. Alternatively, existing components could have their future uses restricted and/or be recalled.

FIG. 8 shows a method 800 in which a user can provide and edit information of a component produced using the methods and systems above. In a first step, the method interfaces with a database, such as database 530, so that a user can search 810 for a unique identifier. Upon locating the unique identifier, information relating to at least one property associated with a component on which the unique identifier is located, is provided 820. At this point, all of the properties listed above can be displayed. Images of the component can also be displayed. Hyperlinks to related components, installation guides, and systems in which the component is used can also be provided. Together, an extensive history and knowledge of all aspects of the component is provided. A user can then review these properties and edit 830 any of the properties. It would be appreciated that the properties may not be complete in that certain properties may not yet have a value, i.e. a blank entry. Therefore, when editing, a user can both alter an existing property and/or of provide a new property. For example, the user may update a compatibility of the component, or provide feedback on installation of the component, such as appropriate torque wrench settings. The edited at least one property is then stored 840.

In the event the search 810 for a unique identifier is not located in the database, a user can be prompted to create an entry for the component with which it is associated. This could occur with legacy components, or incorrect merging of databases. Even if the user is only able to provide limited information, such as a property which indicates the system in which the component is currently used, or a photograph of the component, other users may be able to add additional properties such that better knowledge of the component can be assimilated. It will be appreciated that the method of FIG. 8 provides access to information about the properties listed above including information and manufacturing properties of a given component.

Additionally, the methods of FIGS. 6 and 7 could use the method of FIG. 8. In respect of FIG. 6, a component may be identified by searching for a unique identifier so that associated properties stored in the database can be analyzed, which would then allow an improved performance to be predicted/simulated. In respect of FIG. 7, components with similar or identical properties could be grouped such that a search for any component within that group returns the list of all components within the group.

FIG. 9 shows a user interface/front-end 900 that can be used as part of the method of FIG. 8. As shown, a search for a unique identifier has returned a database entry 910 for a component (part) on which that unique identifier is found. Properties 920 such as those listed above are displayed. It would be understood that the properties listed above are in effect metadata of the component (part). The user interface/front-end 900 provides access to this metadata. A hyperlink 930 is provided to retrieve further information and/or properties of the component (part). The hyperlink may for example link to related components, installation guides, and systems in which the component is used. In one example, the link may be to a kit of components of which the component is part. The kit of components may be for the load handling device or mobile grocery picking robot referenced above. The kit of components may be part of an installation/build guide for the load handling device or mobile grocery picking robot.

In all of the methods and systems described above, the respective identifier may also be used to indicate a feature of the component. For example, if the component has at least one opening to receive a nut or bolt, certain characters of the respective identifier may indicate the size of the nut or bolt (e.g. M12) to be used. Additionally or alternatively, a torque wrench setting for installing the bolt may be indicated. Additionally or alternatively, feature markers may be used in any appropriate location on the component. For example, where the component might have several openings to receive a nut or bolt, appropriate feature markers may be used near the respective openings. In general, a feature marker denotes a region on the component where a specific use and/or installation of the component occurs.

Although the method and systems described above are used in the context of using a PBFAM system, it would be appreciated that any AM, or even non-AM system that employs batch manufacturing could be used.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The invention can take the form of an entirely hardware embodiment, an entirely software embodiment or an embodiment containing both hardware and software elements. In a preferred embodiment, the invention is implemented in software.

Furthermore, the invention can take the form of a computer program embodied as a computer-readable medium having computer executable code for use by or in connection with a computer. For the purposes of this description, a computer readable medium can be any tangible apparatus that can contain, store, communicate, propagate, or transport the program for use by or in connection with the computer. Moreover, a computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The flow diagrams in the figures illustrate the architecture, functionality, and operation of possible implementations of methods according to various embodiments of the present invention. In this regard, each block in the flow diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the flow diagrams, and combinations of blocks in the flow diagrams, can be implemented by special purpose hardware-based systems that perform the specified functions or acts, or combinations of special purpose hardware and computer instructions.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention.

### Example Embodiments

The following is a non-exhaustive list of embodiments, which may be or are claimed.

Embodiment 1. A method for manufacturing components, the method comprising: assigning a respective unique identifier to each respective component of a batch of components; and manufacturing the batch of components using a manufacturing system, wherein each component of the batch of components comprises a respective unique identifier.

Embodiment 2. The method of embodiment 1, wherein the manufacturing system comprises an additive manufacturing, AM, system.

Embodiment 3. The method of embodiment 2, wherein the AM system comprises a powder bed fusion additive manufacturing, PBFAM system.

Embodiment 4. The method of embodiment 3, wherein the method further comprises interfacing with and updating a nesting file to manufacture each component of the batch of components comprising the respective unique identifier.

Embodiment 5. The method of embodiments 3 or 4, wherein each respective unique identifier indicates at least one property of a respective component of the batch of components.

Embodiment 6. The method of embodiment 5, wherein the at least one property comprises a manufacturing property.

Embodiment 7. The method of embodiment 6, wherein the at least one manufacturing property comprises at least one of: a respective location of the respective component of the batch of components within a build volume of the PBFAM system; a powder bed temperature setting of the PBFAM system; an energy source setting of the PBFAM system; a speed of powder spreading of the PBFAM system; an inkjet array setting of the PBFAM system; at least one material used in the PBFAM system; a model of the PBFAM system; a job number of the PBFAM system; a material from which the components are manufactured; a batch number of the batch of components; and a time and/or duration of the manufacturing of the batch of components.

Embodiment 8. The method of embodiments 6 or 7, wherein the method further comprises interfacing with a nesting file to receive the respective locations in the build volume or the at least one manufacturing property.

Embodiment 9. The method of embodiments 7 or 8, wherein the method further comprises interfacing with the PBFAM system to receive at least one of: the powder bed temperature setting of the PBFAM system; the energy source setting of the PBFAM system; the speed of powder spreading of the PBFAM system; and the inkjet array setting of the PBFAM system.

Embodiment 10. The method of embodiment 9, wherein at least one of the powder bed temperature setting of the PBFAM system, the energy source setting of the PBFAM system, the speed of powder spreading of the PBFAM system, and the inkjet array setting of the PBFAM system are received in real-time as the components are manufactured.

Embodiment 11. The method of embodiments 5 to 10, wherein the at least one property comprises information, the information comprising at least one of: a design of the component; a description of the component; an installation instruction of the component; a system in which the component is used; a revision number of the component; a compatibility of the component with other components or a system in which the component is used; geometric dimensioning and tolerancing data of the component; and a location within a load handling device in which the component is used.

Embodiment 12. The method of embodiments 5 to 11, wherein the method further comprises: mapping the at least one property to a respective unique identifier for each component; and using the mapping to indicate the at least one property of a respective component.

Embodiment 13. The method of embodiment 12, further comprising storing the respective unique identifier, the at least one property, and the mapping for each component in a database.

Embodiment 14. The method of any preceding embodiment, wherein the method further comprises: determining a performance of at least one component of the batch of components; upon determining that the performance of at least one component can be improved, using the unique identifier of the at least one component to determine at least one property of the component; and modifying at least one property of a component to improve performance; and manufacturing the component with the modified at least one property.

Embodiment 15. A method comprising: determining a performance of at least one component of a batch of components; upon determining that the performance of at least one component can be improved, using an unique identifier of the at least one component to determine at least one property of the component; modify at least one property of a component to improve performance; and manufacturing the component with the modified at least one property.

Embodiment 16. The method of embodiments 14 or 15, wherein manufacturing the component with the modified at least one property comprises manufacturing the component as part of a subsequent batch of components using a PBFAM system.

Embodiment 17. The method of embodiment 16, wherein the at least one property of the component of the batch of components comprises a mechanical property comprising a respective location within a build volume of the PBFAM system that manufactured the batch of components; and modifying the least one property of the component of the subsequent batch of components comprises modifying the respective location in a build volume of the PBFAM system that manufactures the subsequent batch of components.

Embodiment 18. The method of embodiment 17, wherein the method further comprises: interfacing with a nesting file to modify the respective location in the build volume of the PBFAM system that manufactures the subsequent batch of components.

Embodiment 19. The method of embodiments 17 or 18, wherein modifying the respective location comprises at least one of: constraining rotational freedom of each component; prioritizing components; defining no-build zones to ensure a minimum spacing between parts; forming sacrificial cases/covers to group and/or protect certain components; altering the total number of components in the build volume; and altering a thickness of each PBFAM layer that is used to form the components in the PBFAM system.

Embodiment 20. The method of embodiments 14 or 15, wherein the at least one property of the component of the batch of components comprises a mechanical property comprising at least one of: the powder bed temperature setting of the PBFAM system, the energy source setting of the PBFAM system, the speed of powder spreading of the PBFAM system, and the inkjet array setting of the PBFAM system; and modifying the at least property of the component of the subsequent batch of components comprises modifying at least one of the powder bed temperature setting of the PBFAM system that manufactures the subsequent batch of components, the energy source setting of the PBFAM system that manufactures the subsequent batch of components, the speed of powder spreading in the PBFAM system that manufactures the subsequent batch of components, and the inkjet array setting that of the PBFAM system that manufactures the subsequent batch of components.

Embodiment 21. The method of embodiments 14 to 20, the method further comprising assigning a respective unique identifier to the component or each respective component of the subsequent batch of components.

Embodiment 22. The method of embodiment 21, wherein each respective identifier indicates at least one property of a respective component of the subsequent batch of components; and wherein each component of the subsequent batch of components comprises a respective unique identifier.

Embodiment 23. The method of embodiments 14 to 22, wherein the method further comprises: determining whether at least one component of a plurality of components has a similar or identical property to the component for which it was determined that performance can be improved; and upon determining that at least one component of the plurality of components has a similar or identical property to the component for which it was determined that performance can be improved, providing the or each respective unique identifier of the or each component of the plurality of components.

Embodiment 24. The method of any preceding embodiment wherein the unique identifier indicates a feature of the component, or wherein manufacturing the batch of components further comprises forming at least one feature identifier on the component.

Embodiment 25. The method of any preceding embodiment, wherein each respective identifier is formed by an embossing or a debossing on each respective component, or the method of embodiment 24, wherein the at least one feature identifier is formed by an embossing or a debossing on each respective component.

Embodiment 26. The method of any preceding embodiment, wherein each component of the batch of components comprises the respective unique identifier on a designated area of the component.

Embodiment 27. A computer program comprising instructions which, when the program is executed by a computer, cause the computer to carry out the method of any of embodiments 1 to 26.

Embodiment 28. A data processing system comprising a processor configured to carry out the method of embodiments 1 to 26.

Embodiment 29. A mobile grocery picking robot or a load handling device having a component manufactured by the method of embodiments 1 to 26.

Embodiment 30. A component, wherein the component is manufactured by the method of embodiments 1 to 26.

Embodiment 31. A computer-implemented method for determining properties of a component, the method comprising: searching a database for an unique identifier; upon locating the unique identifier, providing at least one property associated with a component; receiving at least one input to edit the at least one property associated with a component; and storing the edited at least one property.

Embodiment 32. The method of embodiment 31, wherein the at least one property comprises a manufacturing property.

Embodiment 33. The method of embodiment 32, wherein the at least one manufacturing property comprises at least one of: a respective location of the respective component of the batch of components within a build volume of the PBFAM system; a powder bed temperature setting of the PBFAM system; an energy source setting of the PBFAM system; a speed of powder spreading of the PBFAM system; an inkjet array setting of the PBFAM system; at least one material used in the PBFAM system; a model of the PBFAM system; a job number of the PBFAM system; a batch number of the batch of components; a material from which the components are manufactured; and a time and/or duration of the manufacturing of the batch of components.

Embodiment 34. The method of embodiments 31 to 33, wherein the at least one property comprises information, the information comprising at least one of: a design of the component; a description of the component; an installation instruction of the component; a system in which the component is used; a revision number of the component; a compatibility of the component with other components or a system in which the component is used; geometric dimensioning and tolerancing data of the component; and a location within a load handling device in which the component is used.

Embodiment 35. The method of embodiments 31 to 34, wherein an image of the component is displayed upon locating the unique identifier.

Embodiment 36. The method of embodiments 31 to 35, wherein receiving at least one input comprises receiving the at least one input from a user or a computing device.

Embodiment 37. A computer program comprising instructions which, when the program is executed by a computer, cause the computer to carry out the method of embodiments 31 to 36.

Embodiment 38. A data processing system comprising a processor configured to carry out the method of embodiments 31 to 36.

Embodiment 39. A computer-implemented method for generating a nesting file for manufacturing components using a powder bed fusion additive manufacturing, PBFAM system, the method comprising: receiving a nesting file; assigning a respective unique identifier to each respective component of a batch of components; and updating the nesting file such that each component of the batch of components comprises a respective unique identifier when manufactured using the PBFAM system.

Embodiment 40. The method of embodiment 39, the method comprising: mapping at least one property to a respective unique identifier for each component; and using the updated nesting file to indicate at least one property of a respective component.

Embodiment 41. The method of embodiment 40, wherein the at least one property comprises a manufacturing property.

Embodiment 42. The method of embodiment 41, wherein the at least one manufacturing property comprises at least one of: a respective location of the respective component of the batch of components within a build volume of the PBFAM system; a powder bed temperature setting of the PBFAM system; an energy source setting of the PBFAM system; a speed of powder spreading of the PBFAM system; an inkjet array setting of the PBFAM system; at least one material used in the PBFAM system; a model of the PBFAM system; a job number of the PBFAM system; a batch number of the batch of components; a material from which the components are manufactured; and a time and/or duration of the manufacturing of the batch of components.

Embodiment 43. The method of embodiments 40 or 41, wherein the at least one property comprises information, the information comprising at least one of: a design of the component; a description of the component; an installation instruction of the component; a system in which the component is used; a revision number of the component; a compatibility of the component with other components or a system in which the component is used; geometric dimensioning and tolerancing data of the component; and a location within a load handling device in which the component is used.

What is claimed is:

1. A method, comprising:
determining a performance of at least one component of a batch of components;
upon determining that the performance of at least one component can be improved, using a unique identifier of the at least one component to determine at least one property of the component;
modifying at least one property of a component to improve performance, wherein the at least one property of the component of the batch of components comprises a mechanical property comprising a respective location within a build volume of a powder bed fusion additive manufacturing, PBFAM, system that manufactured the batch of components, wherein modifying the at least one property of the component comprises modifying the respective location in a build volume of a PBFAM system that manufactures a subsequent batch of components; and
manufacturing the component with the modified at least one property, wherein manufacturing the component with the modified at least one property comprises manufacturing the component as part of the subsequent batch of components using a PBFAM system.

2. The method of claim 1, wherein the method further comprises interfacing with a nesting file to modify the respective location in the build volume of the PBFAM system that manufactures the subsequent batch of components.

3. The method of claim 1, wherein modifying the respective location comprises at least one of:
constraining rotational freedom of each component;
prioritizing components;
defining no-build zones to ensure a minimum spacing between parts;
forming sacrificial cases/covers to group and/or protect certain components;
altering a total number of components in the build volume; and
altering a thickness of each PBFAM layer that is used to form the components in the PBFAM system.

4. The method of claim 1, wherein the at least one property of the component of the batch of components comprises a mechanical property comprising at least one of:
a powder bed temperature setting of the PBFAM system, an energy source setting of the PBFAM system, a speed of powder spreading of the PBFAM system, and an inkjet array setting of the PBFAM system; and
modifying the at least one property of the component of the subsequent batch of components comprises modifying at least one of the powder bed temperature setting of the PBFAM system that manufactures the subsequent batch of components, the energy source setting of the PBFAM system that manufactures the subsequent batch of components, the speed of powder spreading in the PBFAM system that manufactures the subsequent batch of components, and the inkjet array setting that of the PBFAM system that manufactures the subsequent batch of components.

5. The method of claim 1, the method further comprising assigning a respective unique identifier to the component or each respective component of the subsequent batch of components.

6. The method of claim 5, wherein:
each respective identifier indicates at least one property of a respective component of the subsequent batch of components, and
each component of the subsequent batch of components comprises a respective unique identifier.

7. The method of claim 1, wherein the method further comprises:
determining whether at least one component of a plurality of components has a similar or identical property to the component for which it was determined that performance can be improved; and
upon determining that at least one component of the plurality of components has a similar or identical property to the component for which it was determined that performance can be improved, providing the or each respective unique identifier of the or each component of the plurality of components.

8. The method of claim 6, wherein the unique identifier indicates a feature of the component, or wherein manufacturing the subsequent batch of components further comprises forming at least one feature identifier on the component.

9. The method of claim 6, wherein each respective unique identifier is formed by an embossing or a debossing on each respective component.

10. The method of claim 8, wherein the at least one feature identifier is formed by an embossing or a debossing on each respective component.

11. The method of claim 1, wherein each component of the batch of components comprises the respective unique identifier on a designated area of the component.

12. A computer program comprising instructions which, when the program is executed by a computer, cause the computer to:
determine a performance of at least one component of a batch of components;
upon determining that the performance of at least one component can be improved, using a unique identifier of the at least one component to determine at least one property of the component;
modify at least one property of a component to improve performance, wherein the at least one property of the component of the batch of components comprises a mechanical property comprising a respective location within a build volume of a powder bed fusion additive manufacturing, PBFAM, system that manufactured the batch of components, wherein modifying the at least one property of the component comprises modifying the respective location in a build volume of a PBFAM system that manufactures a subsequent batch of components; and
manufacture the component with the modified at least one property, wherein manufacturing the component with the modified at least one property comprises manufacturing the component as part of the subsequent batch of components using a PBFAM system.

13. A component, wherein the component is manufactured by the method of claim 1.
